(19) United States
(12) Patent Application Publication
(10) Pub. No.: US 2022/0066299 A1
(43) Pub. Date: Mar. 3, 2022

(54) FRAME MODULE AND PROJECTION DEVICE

(71) Applicant: Coretronic Corporation, Hsin-Chu (TW)

(72) Inventors: Chung-Hsien Yen, Hsin-Chu (TW); Meng-Chu Hung, Hsin-Chu (TW)

(73) Assignee: Coretronic Corporation, Hsin-Chu (TW)

(21) Appl. No.: 17/378,780

(22) Filed: Jul. 19, 2021

(30) Foreign Application Priority Data
Aug. 28, 2020 (CN) 202021837752.0

(51) Int. Cl. G03B 21/14; G03B 21/16

(52) U.S. Cl. CPC G03B 21/145; G03B 21/16

(57) ABSTRACT

The disclosure provides a frame module, including multiple brackets, multiple connecting blocks, and multiple appearance panels. The brackets and the connecting blocks are connected to each other to define a cuboid containing space, in which any one of the connecting blocks is connected between the three brackets, and any one of the appearance panels is adjacent to the four brackets and the four connecting blocks to form a rectangular surface of the containing space. A projection device is also provided. The frame module and the projection device adapt the brackets and the connecting blocks having better structural commonality to provide greater convenience in assembly without the dilemma of design changes made due to overlapping installation and assembly requirements, thereby expanding the scope of application and improving the operational convenience of the frame module and the projection device.

### CROSS-REFERENCE TO RELATED APPLICATION

This application claims the priority benefit of China application serial no. 202021837752.0, filed on Aug. 28, 2020. The entirety of the above-mentioned patent application is hereby incorporated by reference herein and made a part of this specification.

### BACKGROUND

### Technical Field

The present application relates to a frame module and a projection device.

### Description of Related Art

The housing of a conventional projection device is mostly assembled with plastic appearance parts, using buckles or screws to form a containing space for assembling a power supply, a light engine, and other related modules.

When it comes to the housing, in addition to its containing function as mentioned, its structural strength must also be taken into consideration to avoid any possible damage. Therefore, when designing the plastic appearance parts, besides the use of thicker plastic sheets, relevant structures that are sufficient to improve the structural strength of the housing are also adopted. However, for the plastic appearance parts, those who aspire to achieve the above functions usually complicate the structure of the plastic appearance parts, thus causing pre-production problems for the plastic appearance parts. For example, the design and manufacturing of molds that are required to correspond to one another tend to increase the production time and cost due to the complex structure as mentioned.

Furthermore, the buckle structure of the plastic appearance parts may also be damaged easily by external force during maintenance or disassembly. Meanwhile, some electronic modules are substantially assembled on the inner surface of the plastic appearance parts, forcing the user to pay extra attention to the linkage arrangement between the plastic appearance parts and the electronic modules when disassembling the housing. For example, the operation panel of an electronic module is assembled on a plastic appearance part and is connected to the body of the electronic module in the housing through wires. Therefore, extra attention must be paid to avoid damages or breakages of the wires when disassembling the plastic appearance parts. And these concerns trouble the users when they disassemble or maintain the housing.

Accordingly, it has become a problem for relevant technicians to provide a better housing structure such that the projection device may reduce the user's troubles during disassembly or maintenance.

The information disclosed in this Background section is only for enhancement of understanding of the background of the described technology and therefore it may contain information that does not form the prior art that is already known to a person of ordinary skill in the art. Furthermore, the information disclosed in the Background section does not mean that one or more problems to be resolved by one or more embodiments of the present application was acknowledged by a person of ordinary skill in the art.

### SUMMARY

The disclosure provides a frame module and a projection device having a simple configuration and good structural strength, which are convenient in maintenance and disassembly for stacking and combining them to expand the scope of application and improve the convenience of operation.

Other objectives and advantages of the disclosure may be further illustrated by the technical features broadly embodied and described as follows.

To achieve one, part, or all of the aforementioned objectives or other objectives, one embodiment of the disclosure provides a frame module, including multiple brackets, multiple connecting blocks, and multiple appearance panels. The brackets and the connecting blocks are connected to each other to define a cuboid containing space, and any one of the connecting blocks is connected between three brackets. And any one of the appearance panels is adjacent to four brackets and four connecting blocks to form a rectangular surface of the containing space.

To achieve one, part, or all of the aforementioned objectives or other objectives, one embodiment of the disclosure provides a projection device, including a light-source module, a light-engine module, a power-supply module, a fan module, and a frame module. The light-source module is adapted to provide a light beam. The light-engine module is adapted to project the light beam. The power-supply module is adapted to provide the power required for operating the projection device. And the fan module is adjacent to the light-engine module. The frame module includes multiple brackets, multiple connecting blocks, and multiple appearance panels. The brackets and the connecting blocks are connected to each other to define a cuboid containing space to contain the light-source module, the light-engine module, the power-supply module, and the fan module. Any one of the connecting blocks is connected between three brackets. And any one of the appearance panels is adjacent to four brackets and four connecting blocks to form a rectangular surface of the containing space.

Based on the above description, both the frame module and the projection device having the said frame module can achieve the structural strength as required and improve the operational convenience through a simple structural configuration. The frame module is composed of multiple brackets and multiple connecting blocks that define a cuboid containing space for accommodating the light-source module, the light-engine module, the power-supply module, and the fan module of the projection device.

Moreover, just like the cuboid structure presented by the frame module, these brackets only need to be adjusted according to the required size to be assembled with the connecting blocks, making the appearance panels adjacent to four brackets and four connecting blocks to form the rectangular surfaces of the containing space. In other words, as the assembly structure of the brackets and the connecting blocks meets the assembly requirements without being changed, the structural complexity of the frame module may be effectively simplified, and thus reducing the production time and requirements of the frame module.

Furthermore, it is through the brackets and the connecting blocks having better structural commonality that greater convenience in assembly may be provided without the dilemma of design changes made due to overlapping installation and assembly requirements, thereby expanding the scope of application and improving the operational convenience of the frame module and the projection device.

Other objectives, features and advantages of the present application will be further understood from the further technological features disclosed by the embodiments of the present application wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the present application, and are incorporated in and constitute a part of this specification. The drawings illustrate embodiments of the present application and, together with the description, serve to explain the principles of the present application.

FIG. 1 is a schematic view of a projection device according to an embodiment of the present application.

FIG. 2A is an exploded view of the projection device of FIG. 1.

FIG. 2B is a schematic view of part of the components of the frame module of FIG. 2A.

FIG. 3A and FIG. 3B are schematic assembly diagrams of part of the components of the frame module.

FIG. 3C and FIG. 3D are schematic assembly diagrams of the connecting blocks and the decorative covers.

FIG. 4 is an enlarged schematic diagram of part of the structure of the frame module.

FIG. 5 is a schematic assembly diagram of part of the components of the frame module.

### DESCRIPTION OF THE EMBODIMENTS

In the following detailed description of the preferred embodiments, reference is made to the accompanying drawings which form a part hereof, and in which are shown by way of illustration specific embodiments in which the present application may be practiced. In this regard, directional terminology, such as “top,” “bottom,” “front,” “back,” etc., is used with reference to the orientation of the Figure(s) being described. The components of the present application can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present application. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” “mounted,” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

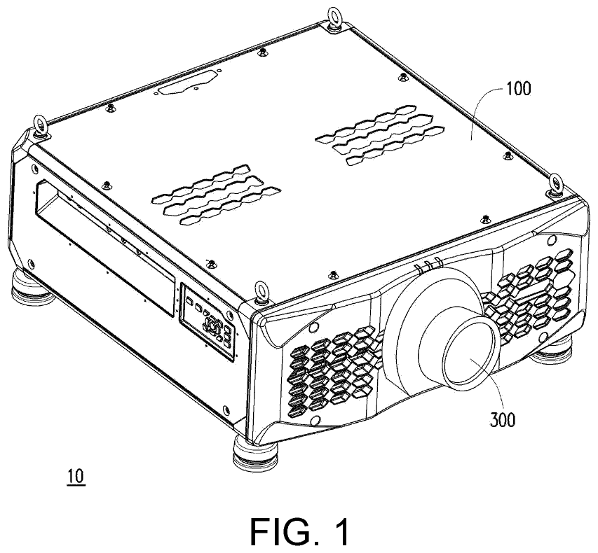

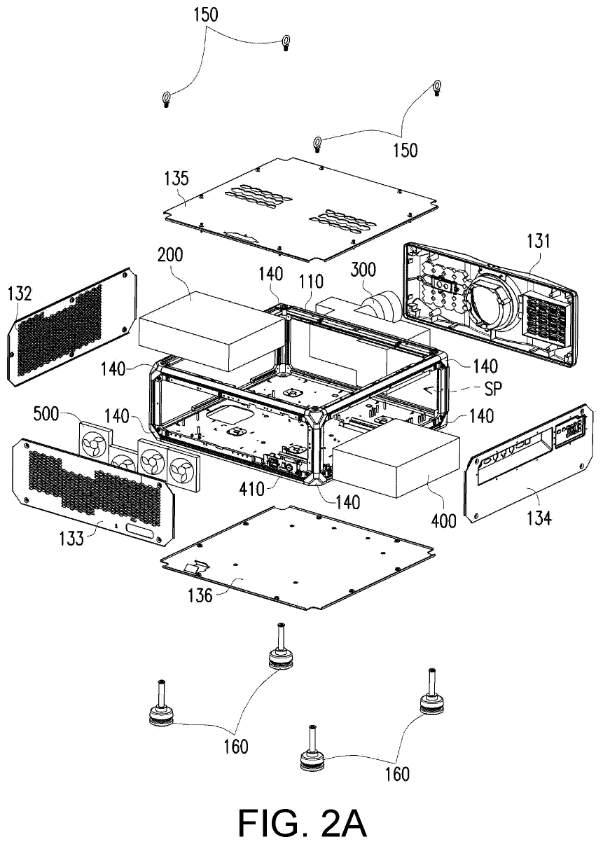

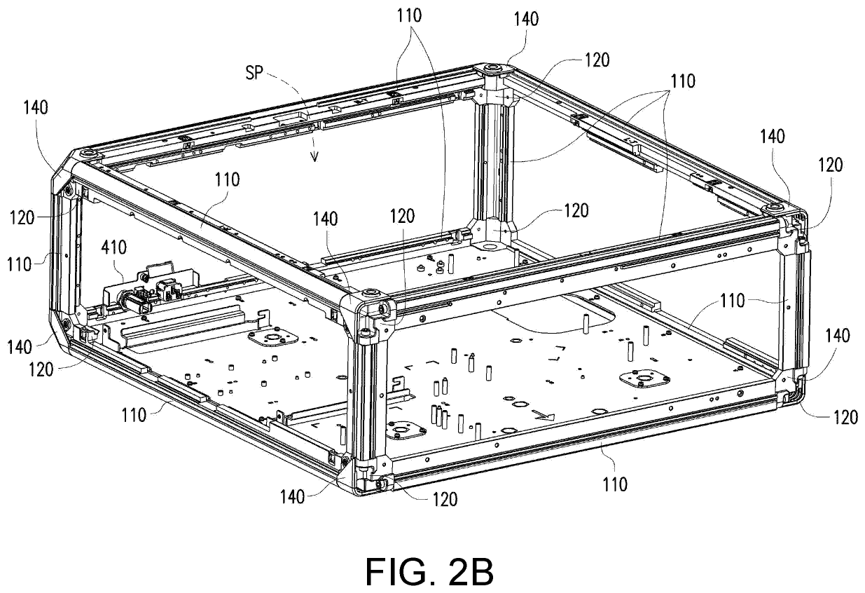

FIG. 1 is a schematic view of a projection device according to an embodiment of the present application. FIG. 2A is an exploded view of the projection device of FIG. 1. FIG. 2B is a schematic view of part of the components of the frame module of FIG. 2A. Please refer to FIG. 1, FIG. 2A, and FIG. 2B at the same time. In the present embodiment, a projection device 10 includes a frame module 100, a light-source module 200, a light engine module 300, a power-supply module 400, and a fan module 500. The frame module 100 includes a plurality of brackets 110, a plurality of connecting blocks 120, and a plurality of appearance panels 131 to 136, in which the brackets 110 and the connecting blocks 120 are connected to one another to define a cuboid containing space SP, in which any one of the connecting blocks 120 is connected between the three brackets 110, and any one of the appearance panels 131 to 136 is adjacent to the four brackets 110 and the four connecting blocks 120 to form a rectangular surface of the containing space SP.

Furthermore, the housing structure formed by the brackets 110, the connecting blocks 120, and the appearance panels 131 to 136 is adapted to assemble the aforementioned light-source module 200, the light engine module 300, the power-supply module 400, and the fan module 500 in the containing space SP, in which the light-source module 200 is adapted to provide a light beam, the light engine module 300 is adapted to project the light beam to the outside of the projection device 10, the power-supply module 400 is adapted to provide the power required for operating the projection device 10, and the fan module 500 is provided in the containing space SP and adjacent to the light engine module 300 for dissipating heat from the containing space SP and the related modules located therein.

As shown in FIG. 2A, the appearance panels 131 to 136 are arranged separately on the six sides of the containing space SP to close it up, leaving only the openings necessary for the light engine module 300 and a control assembly 410 to pass through and also for air convection to facilitate the heat dissipation. The aforementioned light-source module 200, the light engine module 300, the power-supply module 400, and fan module 500 are substantially carried on the appearance panel 136. It is thank to this configuration that the appearance panels 131 to 136 can avoid the situation of linkage arrangement with the internal electronic modules like the existing device. As shown in FIG. 2A, the power-supply module 400 has a control component 410 (for example, a start switch or a knob of the projection device 10) connected through wires (not shown), in which the control component 410 is assembled on the brackets 110, and the wires (not shown) are hidden in the brackets 110, so when the projection device 10 is maintained and disassembled, the user does not need to worry about damaging the wires or the electronic modules in the containing space SP due to improper force. Accordingly, the structural configuration of the frame module 100 and the projection device 10 provided with the same of the present embodiment configured by using the brackets 110 and the connecting blocks 120 may improve the convenience and safety of the user during operation.

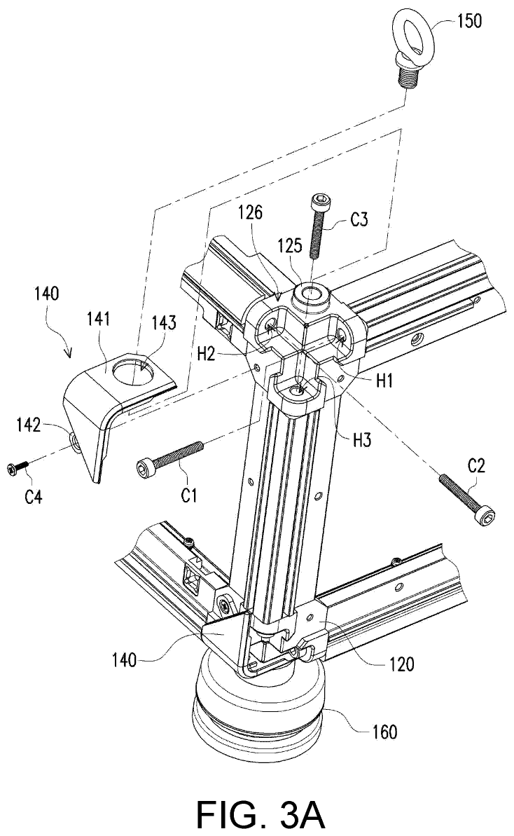

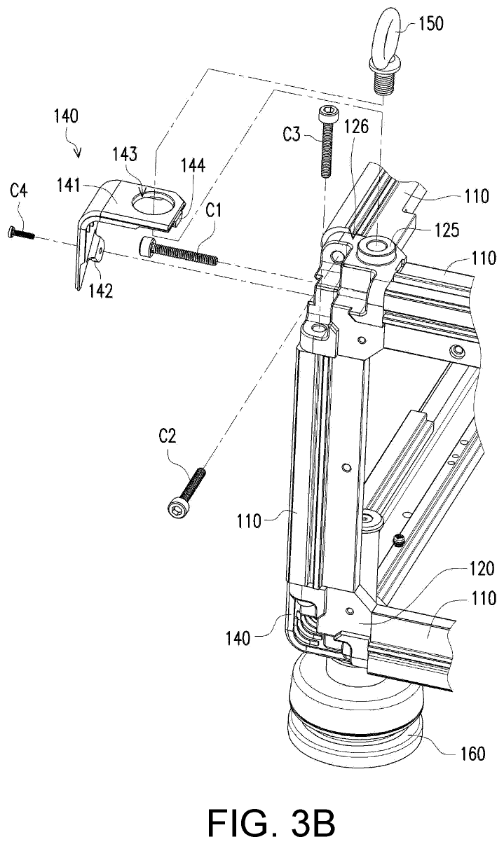

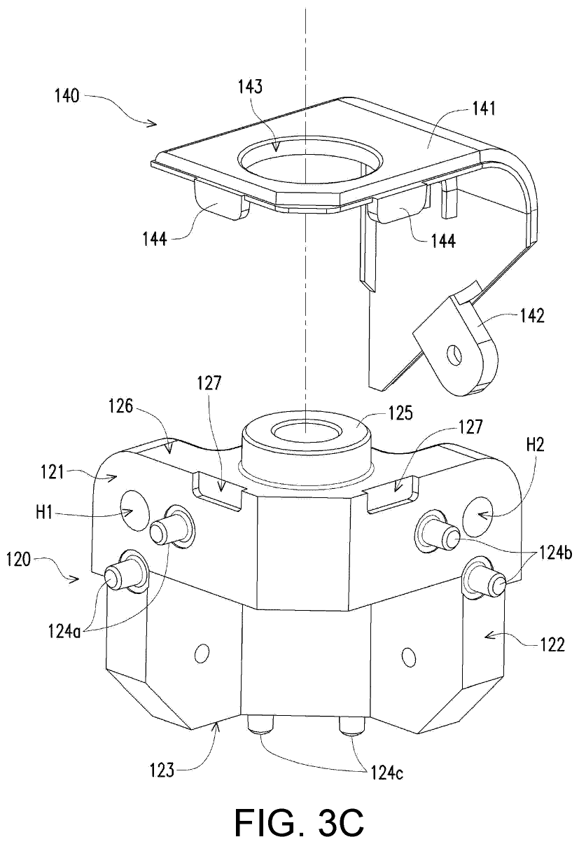

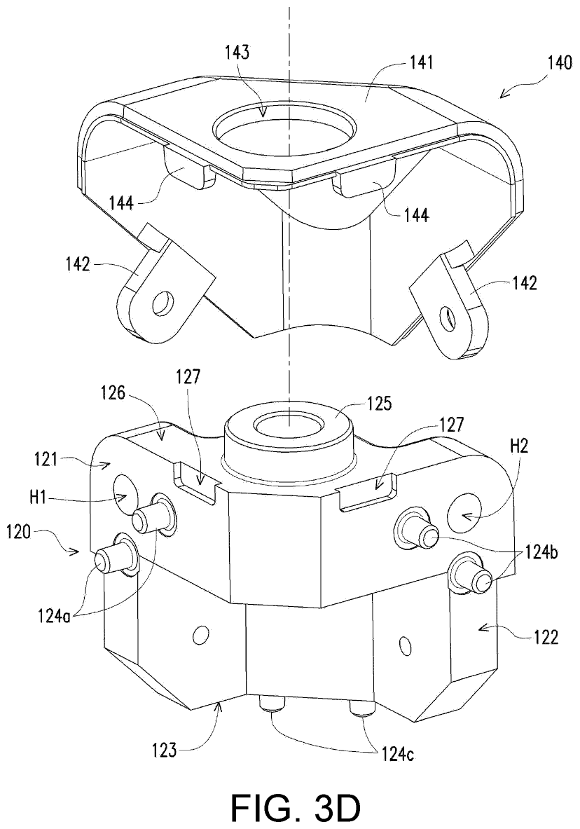

FIG. 3A and FIG. 3B are schematic assembly diagrams of part of the components of the frame module. Please refer to FIGS. 3A and 3B at the same time. Since the same connecting block 120 is assembled between the three adjacent brackets 110, the frame module 100 of the present embodiment further includes three locking members Cl to C3 for connecting the different parts of the connecting block 120 respectively with the three brackets 110. FIG. 3C and FIG. 3D are schematic assembly diagrams of the connecting blocks and the decorative covers. Referring to FIG. 3C and FIG. 3D, furthermore, each of the connecting blocks 120 has three junctures 121, 122, and 123 to connect three brackets 110, and the junctures 121, 122, and 123 respectively have a plurality of positioning columns 124a to 124c. As shown in FIG. 3A and FIG. 3B, one of the locking members Cl to C3 and the positioning columns 124a to 124c located at the same junctures 121, 122, and 123 are inserted into the bracket 110 in the same direction, so that the connecting block 120 and the bracket 110 are locked together through the locking members C1 to C3.

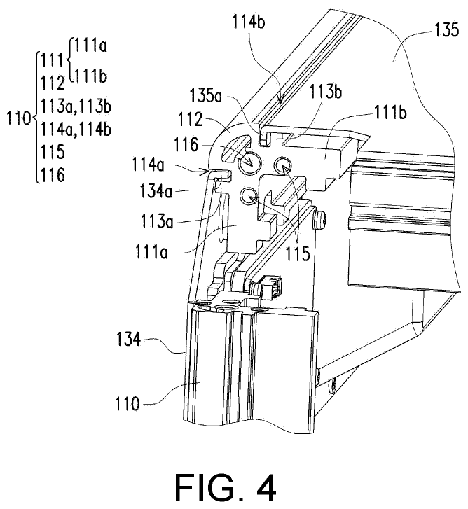

FIG. 4 is an enlarged schematic diagram of part of the structure of the frame module. Please first refer to FIG. 3A, FIG. 3B, and FIG. 4. In the present embodiment, each of the brackets 110 has an L-shaped column 111 and a fan-shaped column 112. The L-shaped column 111 includes two wings 111a and 111b. And the fan-shaped column 112 is located between the two wings 111a and 111b, and the three form an integral structure. The bracket 110 also has two protrusions 113a and 113b located on the two wings 111a and 111b, and grooves 114a and 114b are formed between each of the protrusions 113a and 113b and the fan-shaped column 112, so that the bends 134a and 135a as the edges of the panel body of the appearance panels 134 and 135 may be inserted into the grooves 114a and 114b, making the fan-shaped column 112 adjacent to the two appearance panels 134 and 135, and making the bracket 110 support the appearance panels 134 and 135 through its protrusions 113a and 113b.

Furthermore, please refer to FIG. 3A (or FIG. 3B), FIG. 3C, and FIG. 4 at the same time. In the present embodiment, three partial planes (that is, the junctures 121, 122, and 123) of the connecting block 120 abut respectively against the planes of the three brackets 110. By referring also to the connecting block 120 in the upper part of FIG. 3A or FIG. 3B, it may be indicated that the juncture 122, for example, abuts on a plane formed by the wings 111a and 111b and the fan-shaped column 112 shown in FIG. 4, that is, when assembling the bracket 110 and the connecting block 120, the positioning column 124b is adapted first to pass through and be positioned in a positioning hole 115 of the bracket 110, and then the locking member C2 is adapted to pass through an opening H2 of the connecting block 120 and then lock into a locking hole 116 of the bracket 110, combining the connecting block 120 smoothly with a bracket 110. And the same goes for the other two junctures 121 and 123. Note that the positioning columns 124a and 124c on the junctures 121 and 123 and the opening H1 on the juncture 121 shown in FIG. 3C are the same as described above, which is a structure of the connecting block 120 combined with the other two brackets through the locking members Cl and C2. The same will not be repeated hereinafter.

Please refer to FIG. 3A to FIG. 3C again. In the present embodiment, each of the connecting blocks 120 also has a protruding platform 125, which is different from the three junctures 121 to 123 where the connecting block 120 contacts the bracket 110. The protruding platform 125 is provided to extend away from one of the junctures 123 as shown in FIG. 2B, and the protruding platform 125 protrudes from the containing space SP and may be adapted to carry another frame module 100. In other words, since the frame module 100 of the present embodiment has the structurally common brackets 110 and the connecting blocks 120, the user may further stack and combine multiple frame modules 100, that is, using the protruding platform 125 of each connecting block 120 as a contact support between the two frame modules 100, such that the stacked structure of the frame modules 100 is stable and not easy to fall.

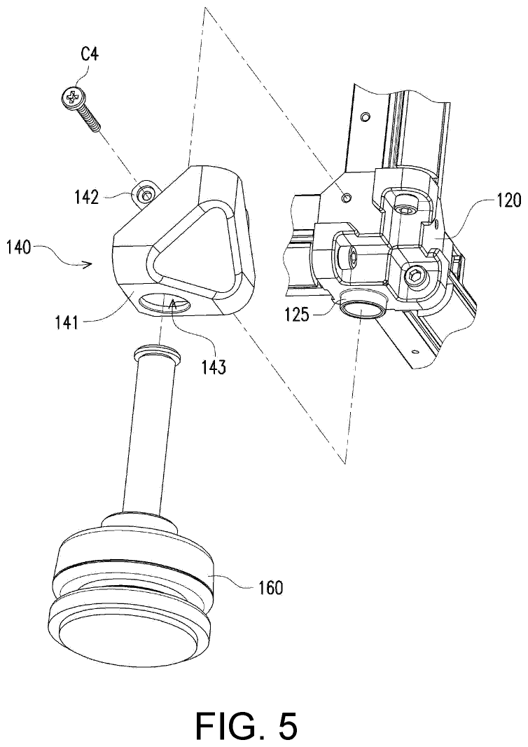

FIG. 5 is a schematic assembly diagram of part of the components of the frame module. Please refer to FIG. 3A, FIG. 3B, and FIG. 5 at the same time. In the present embodiment, the frame module 100 further includes a lifting ring 150 and a foot pad 160, which may be respectively assembled on or detached from the protruding platform 125 of the connecting block 120. And the lifting ring 150 is adapted to allow the projection device 10 to be suspended to be moved or installed, for example, on the ceiling while the foot pad 160 may provide the stability of bearing the frame module 100 and provide the cushioning effect required by the projection device 10. At the same time, due to the disassembly and assembly features of the lifting ring 150 and the foot pad 160 relative to the connecting block 120, the possibility of the various usages of the frame module 100 increases without restricting the upper and lower sides of the frame module 100 by the location of the lifting ring 150 and the foot pad 160. In other words, as the frame module 100 has a common structure due to the connecting block 120, the lifting ring 150 and the foot pad 160 may be assembled on any connecting block 120 according to usage needs. For example, the lifting ring 150 and the foot pad 160 shown in FIG. 2A are swapped to be assembled on the connecting block 120, so that the frame module 100 may be provided upside down.

Please refer to FIG. 3C and FIG. 3D again. In the present embodiment, the frame module 100 further includes the decorative cover 140. The decorative cover 140 includes a body 141, a lug 142, an opening 143, and a buckle protrusion 144, in which the lug 142 extends from the body 141 as shown in FIG. 3A and FIG. 3B and is locked with the connecting block 120 by the locking member C4 which passes through the lug 142. Furthermore, the opening 143 corresponds to the protruding platform 125 of the connecting block 120, and the protruding platform 125 is located on the plane 126, so that the protruding platform 125 passes through the opening 143 and protrudes from the containing space SP. Here, the plane 126 is different from the three aforementioned junctures 121 to 123 and substantially faces away from the juncture 123. In addition, the connecting block 120 has a slot 127 corresponding to the buckle protrusion 144 of the decorative cover 140. The buckle protrusion 144 is buckled in the slot 127, through which the decorative cover 140 and the connecting block 120 are assembled together. The combining structure of the decorative cover 140 and the connecting block 120 is not limited thereto. In another embodiment which is not illustrated, the connecting block 120 may also be provided with the buckle protrusion 144, and the decorative cover 140 may be provided with the slot 127.

Note that the decorative covers 140 shown in FIG. 3D and FIG. 3C are only slightly different in the appearance, but their combining structures corresponding to the connecting block 120 are not different. For example, the appearance of the decorative cover 140 of the present embodiment shown in FIG. 3D is slightly reduced to match the appearance panel 131 (as shown in FIG. 2A), that is, except for the appearance panel 131, the other appearance panels 132 to 136 and the decorative cover 140 adjacent to them are substantially as shown in FIG. 3D (or FIG. 5). However, whether it is the decorative cover 140 shown in FIG. 3C or the one in FIG. 3D, it still has a corresponding structure sufficient to be combined with the connecting block 120.

In summary, in the embodiments of the present application as mentioned above, both the frame module and the projection device having the said frame module can achieve the structural strength as required and improve the operational convenience through a simple structural configuration. The frame module is composed of multiple brackets and multiple connecting blocks to define a cuboid containing space for accommodating the light-source module, the light-engine module, the power-supply module, and the fan module of the projection device.

Moreover, just like the cuboid structure presented by the frame module, these brackets only need to be adjusted according to the required size to assembled the brackets and the connecting blocks together, making the appearance panels adjacent to the four brackets and the four connecting blocks and form the rectangular surfaces of the containing space. In other words, as the assembly structure of the brackets and the connecting blocks meets the assembly requirements without being changed, the structural complexity of the frame module may be effectively simplified, and thus reducing the production time and requirements of the frame module. At the same time, if each module in the containing space is provided with an interface or component for users to operate, it can be assembled on the brackets accordingly, and the wires may be stored in the brackets, thereby eliminating the linkage arrangement between the appearance panels and these modules, alleviating the users' concerns during maintenance and disassembly.

In general, the frame structure and the projection device of the present application adapt the brackets and the connecting blocks having better structural commonality to provide greater convenience in assembly without the dilemma of design changes made due to overlapping installation and assembly requirements, thereby expanding the scope of application and improving the operational convenience of the frame module and the projection device.

The foregoing description of the preferred embodiments of the present application has been presented for purposes of illustration and description. It is not intended to be exhaustive or to limit the present application to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the present application and its best mode practical application, thereby to enable persons skilled in the art to understand the present application for various embodiments and with various modifications as are suited to the particular use or implementation contemplated. It is intended that the scope of the present application be defined by the claims appended hereto and their equivalents in which all terms are meant in their broadest reasonable sense unless otherwise indicated. Therefore, the term “the invention,” “the present application,” or the like does not necessarily limit the claim scope to a specific embodiment, and the reference to particularly preferred exemplary embodiments of the present application does not imply a limitation on the present application, and no such limitation is to be inferred. The present application is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the present application. It should be appreciated that variations may be made in the embodiments described by persons skilled in the art without departing from the scope of the present application as defined by the following claims. Moreover, no element and component in the present disclosure is intended to be dedicated to the public regardless of whether the element or component is explicitly recited in the following claims.

What is claimed is:

1. A frame module, comprising a plurality of brackets, a plurality of connecting blocks, and a plurality of appearance panels, wherein:
the brackets and the connecting blocks are connected to each other and define a cuboid containing space, wherein any one of the connecting blocks is connected between the three brackets; and
any one of the appearance panels is adjacent to the four brackets and the four connecting blocks, forming a rectangular surface of the containing space.

2. The frame module according to claim 1, wherein each of the brackets comprises two protrusions and two grooves, each of the appearance panels comprises a penal body and a bend located at an edge of the penal body, the bend is inserted into the groove, and the protrusion supports the panel body.

3. The frame module according to claim 2, wherein each of the brackets comprises an L-shaped column, and the two protrusions and the two grooves are located respectively on two wings of the L-shaped column.

4. The frame module according to claim 3, wherein the bracket further comprises a fan-shaped column, forming an integral structure with the L-shaped column, and the fan-shaped column is adjacent between the two appearance panels.

5. The frame module according to claim 1, further comprising a plurality of locking members, wherein each of the connecting blocks comprises three junctures connecting the three brackets, each of the junctures comprises a plurality of positioning columns, wherein one of the locking members and the positioning columns located at the same juncture are inserted into the bracket in a same direction, and the locking member locks the connecting block and the bracket together.

6. The frame module according to claim 5, wherein the juncture is a partial plane of the connecting block, the positioning columns protrude from the partial plane, and the locking member passes through the partial plane.

7. The frame module according to claim 6, wherein the three partial planes are orthogonal to one another.

8. The frame module according to claim 5, wherein each of the connecting blocks further comprises a protruding platform different from the three junctures and extending away from one of the junctures, and the protruding platform protrudes from the containing space and is adapted to carry another frame module.

9. The frame module according to claim 8, further comprising a lifting ring, assembled to or dissembled from the protruding platform.

10. The frame module according to claim 8, further comprising a foot pad, assembled to or dissembled from the protruding platform.

11. The frame module according to claim 8, further comprising a decorative cover, wherein the decorative cover comprises one of a buckle protrusion and a slot, the connecting block comprises the other one of the buckle protrusion and the slot, the decorative cover is assembled with the connecting block by buckling the buckle protrusion in the slot, and the protruding platform passes through the decorative cover.

12. The frame module according to claim 1, wherein the brackets are respectively extruded metal members.

13. A projection device, comprising a frame module, a light-source module, a light-engine module, a power-supply module, and a fan module, wherein:
the frame module comprises a plurality of brackets, a plurality of connecting blocks, and a plurality of appearance panels, wherein:
the brackets and the connecting blocks are connected to each other and define a cuboid containing space, wherein any one of the connecting blocks is connected between the three brackets; and
any one of the appearance panels is adjacent to the four brackets and the four connecting blocks, forming a rectangular surface of the containing space, wherein
the light-source module is disposed in the containing space to provide a light beam;
the light-engine module is disposed in the containing space for projecting the light beam;
the power-supply module is disposed in the containing space to provide power required for operating the projection device; and
the fan module is disposed in the containing space to be adjacent to the light-engine module.

14. The projection device according to claim 13, wherein the light-source module, the light-engine module, the power-supply module, and the fan module are carried on one of the appearance panels.

15. The projection device according to claim 14, wherein each of the brackets comprises two protrusions and two grooves, each of the appearance panels comprises a penal body and a bend located at an edge of the penal body, the bend is inserted into the groove, and the protrusion supports the panel body.

16. The projection device according to claim 15, wherein each of the brackets comprises an L-shaped column, and the two protrusions and the two grooves are located respectively on two wings of the L-shaped column.

17. The projection device according to claim 16, wherein each of the brackets further comprises a fan-shaped column, forming an integral structure with the L-shaped column, and the fan-shaped column is adjacent between the two appearance panels.

18. The projection device according to claim 13, wherein the frame module further comprises a plurality of locking members, each of the connecting blocks comprises three junctures connecting the three brackets, each of the junctures comprises a plurality of positioning columns, one of the locking members and the positioning columns located at the same juncture are inserted into the bracket in a same direction, and the locking member locks the connecting block and the bracket together.

19. The projection device according to claim 18, wherein the juncture is a partial plane of the connecting block, the positioning columns protrude from the partial plane, and the locking member passes through the partial plane.

20. The projection device according to claim 19, wherein the three partial planes are orthogonal to one another.

21. The projection device according to claim 18, wherein each of the connecting blocks further comprises a protruding platform different from the three junctures and extending away from one of the junctures, and the protruding platform protrudes from the containing space and is adapted to carry another frame module.

22. The projection device according to claim 21, wherein the frame module further comprises a lifting ring, assembled to or dissembled from the protruding platform.

23. The projection device according to claim 21, wherein the frame module further comprises a foot pad, assembled to or dissembled from the protruding platform.

24. The projection device according to claim 21, wherein the frame module further comprises a decorative cover, the decorative cover comprises one of a buckle protrusion and a slot, the connecting block comprises the other one of the buckle protrusion and the slot, the decorative cover is assembled with the connecting block by buckling the buckle protrusion in the slot, and the protruding platform passes through the decorative cover.

25. The projection device according to claim 13, wherein the brackets are respectively extruded metal members.
